(19) United States
(12) Patent Application Publication
(10) Pub. No.: US 2024/0184292 A1
(43) Pub. Date: Jun. 6, 2024

(54) INFORMATION PROCESSING DEVICE, CONTROL METHOD, AND STORAGE MEDIUM

(71) Applicant: CANON KABUSHIKI KAISHA, Tokyo (JP)

(72) Inventors: SHINJI OHIRA, Tokyo (JP); MASAKAZU FUJIKI, Kanagawa (JP)

(21) Appl. No.: 18/522,615

(22) Filed: Nov. 29, 2023

(30) Foreign Application Priority Data
Dec. 6, 2022 (JP) 2022-194610

(51) Int. Cl. G05D 1/02; B60W 30/165; B60W 40/04; B60W 40/105; B60W 50/14; B60W 60/00

(52) U.S. Cl. CPC G05D 1/0212; B60W 30/165; B60W 40/04; B60W 40/105; B60W 50/14; B60W 60/001; G05D 1/0293; B60W 2050/146; B60W 2554/406; B60W 2554/80; G05D 2201/0216

(57) ABSTRACT

An information processing device includes a route information acquisition unit configured to acquire information on a scheduled route of each of a plurality of movable apparatuses; a congestion degree calculation unit configured to divide a route acquired by the route information acquisition unit into a plurality of sections and calculate a congestion degree indicating a density of movable apparatuses present within the sections for each of the sections; a following route planning unit configured to, on the basis of the congestion degree calculated by the congestion degree calculation unit, determine a following route section in which a movable apparatus performs following route with respect to another movable apparatus and determine whether or not to perform following with respect to each of the plurality of movable apparatuses within the following route section; and a control instruction determination unit configured to determine a control instruction with respect to each of the plurality of movable apparatuses in accordance with a following route plan determined by the following route planning unit.

### BACKGROUND OF THE INVENTION

### Field of the Invention

The present invention relates to an information processing device, a control method, a storage medium, and the like.

### Description of the Related Art

In order to transport goods in factories and warehouses, movable apparatuses such as unmanned automated guided vehicles (AGVs) that automatically move are becoming increasingly widespread. Regarding a method for enhancing transportation efficiency, for example, Japanese Patent Laid-Open No. 2021-177437 discloses a technology for executing following control such that a vehicle-to-vehicle distance to a preceding automated guided vehicle is maintained to become uniform if the vehicle-to-vehicle distance to a preceding automated guided vehicle becomes equal to or shorter than a distance set in advance.

However, the method in Japanese Patent Laid-Open No. 2021-177437 is a method for controlling whether or not to follow a preceding automated guided vehicle, and therefore movement efficiency is low in an environment in which a plurality of movable apparatuses travel.

### SUMMARY OF THE INVENTION

An information processing device according to an embodiment of the present invention includes at least one processor or circuit configured to function as: a route information acquisition unit configured to acquire information on a scheduled route of each of the plurality of movable apparatuses; a congestion degree calculation unit configured to divide a route acquired by the route information acquisition unit into a plurality of sections and calculate a congestion degree indicating a density of movable apparatuses present within the sections for each of the sections; a following route planning unit configured to, on the basis of the congestion degree calculated by the congestion degree calculation unit, determine a following route section in which a movable apparatus performs following route with respect to another movable apparatus and determine whether or not to perform following with respect to each of the plurality of movable apparatuses within the following route section; and a control instruction determination unit configured to determine a control instruction with respect to each of the plurality of movable apparatuses in accordance with a following route plan determined by the following route planning unit.

Further features of the present invention will become apparent from the following description of embodiments with reference to the attached drawings.

### BRIEF DESCRIPTION OF THE DRAWINGS

FIG. 1 is a view showing a situation in which an information processing device according to First Embodiment of the present invention is utilized.

FIG. 2 is a block diagram showing an example of a functional constitution of the information processing device according to First Embodiment.

FIG. 3 is a view showing an example of a hardware constitution of the information processing device.

FIG. 4 is a flowchart showing processing executed by the information processing device in First Embodiment.

FIGS. 5A to 5C are explanatory views of a congestion degree calculation method.

FIG. 6 is a flowchart showing following route plan processing.

FIG. 7 is an explanatory view of a method for performing grouping by destination.

FIG. 8 is an explanatory view of a method for determining a following route section.

FIG. 9 is a flowchart showing control instruction determination processing.

FIG. 10 is an explanatory view of a method for determining a following route start position.

FIG. 11 is a view showing an example of a GUI in the information processing device.

FIG. 12 is a block diagram showing an example of a functional constitution of the information processing device according to Second Embodiment.

FIG. 13 is a flowchart showing processing executed by the information processing device in Second Embodiment.

FIG. 14 is an explanatory view of common route estimation processing.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate description will be omitted or simplified.

### First Embodiment

Hereinafter, First Embodiment of the present invention will be described. In First Embodiment, an example in which the present invention is applied to an automated transportation system that transports goods by controlling a plurality of movable apparatuses will be described.

In this system, routes generated on the basis of transportation tasks are given to a plurality of movable apparatuses under management as movement control instructions so that each of the movable apparatuses to which an instruction has been given transports goods to a destination through autonomous traveling.

However, if the number of movable apparatuses moving at the same time within the same region increases, there is concern that a probability of interference between movable apparatuses will increase and this may lead to a traffic jam. Hence, scheduled routes of all movable apparatuses are divided into a plurality of sections, and the congestion degree is calculated for each of the sections. In a section with a high congestion degree, movable apparatuses are each caused to perform following route with respect to another movable apparatus so that the movable apparatuses travel close to each other with a reduced distance therebetween.

A congestion degree expresses a density of movable apparatuses simultaneously present within a section. An information processing device according to First Embodiment performs control of the automated transportation system that transports goods by controlling a plurality of movable apparatuses.

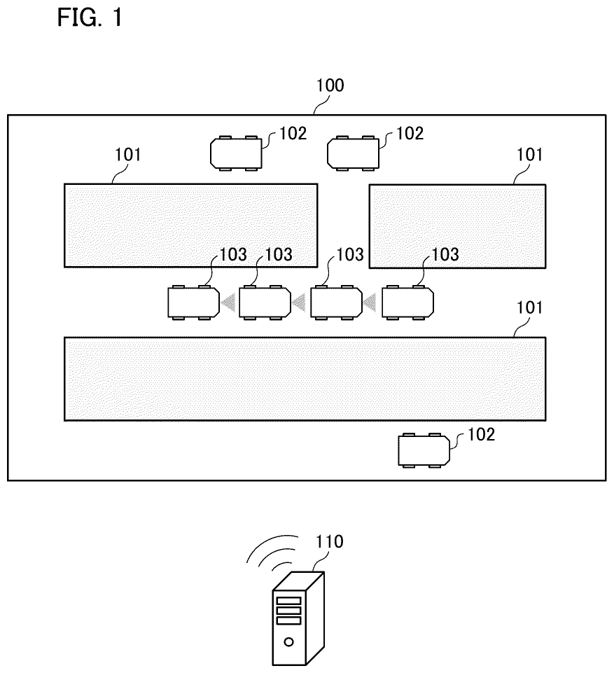

FIG. 1 is a view showing a situation in which an information processing device according to First Embodiment is utilized. An area 100 is a region in a bird's-eye view from above showing a condition in which movable apparatuses move to transport goods. A wall 101 is present in the area 100. Movable apparatuses 102 and movable apparatuses 103 are movable apparatuses performing autonomous traveling.

The movable apparatuses 102 are movable apparatuses traveling in a section that is not congested. The movable apparatuses 103 are movable apparatuses traveling in convoy. The movable apparatuses 102 that are movable apparatuses traveling in a section that is not congested do not perform following route, and they each autonomously travel. Meanwhile, the movable apparatuses 103 are instructed to perform following route according to the present embodiment and travel in convoy.

A central control system 110 is a system for managing movable apparatuses. The central control system 110 includes the information processing device according to the present embodiment. The central control system 110 transmits an instruction as to whether or not to perform following route of each movable apparatus or information on a route section to perform following route to movable apparatuses through communication.

Route information according to the present embodiment is information for expressing a transportation route of a movable apparatus. Constituent elements of route information include a route ID, coordinates of a start position, coordinates of a waypoint, and coordinates of a destination position. Route information further includes a time to start from a start position and a movement speed of a movable apparatus, which can be utilized for judging a time when a movable apparatus moves through the section on the route.

In the present embodiment, a start position indicates a loading position in a transportation route. In the present embodiment, a destination position indicates an unloading position. In the present embodiment, a waypoint indicates a transit position when a movable apparatus moves from a start position to a destination position. All of the three positions are expressed by coordinates (x, y) indicating an arbitrary position on a two-dimensional plane.

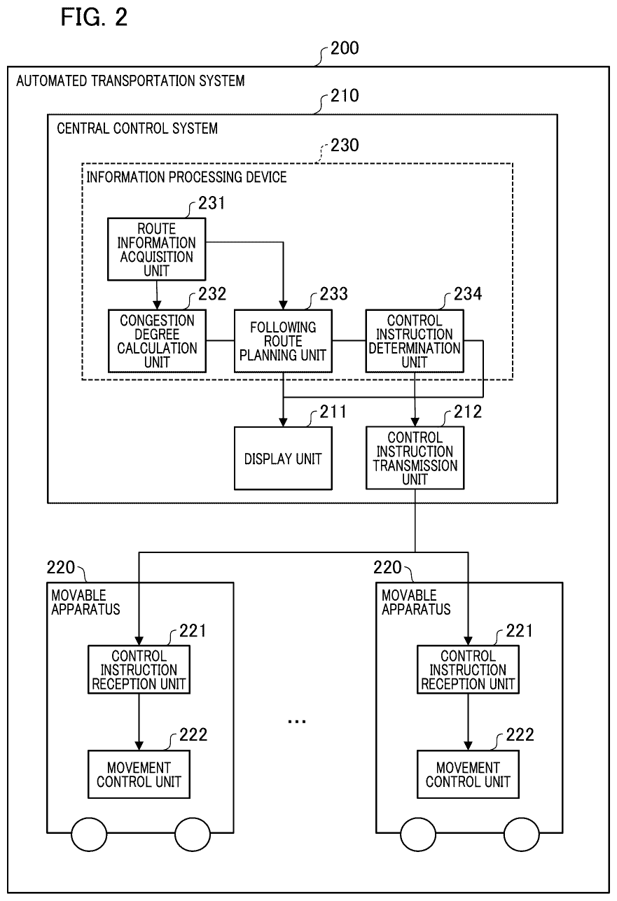

FIG. 2 is a view showing an example of a constitution of an automated transportation system including the information processing device according to the present embodiment. An automated transportation system 200 includes a plurality of movable apparatuses 220 and a central control system 210 for managing the movable apparatuses 220.

The central control system 210 is constituted of an information processing device 230, a display unit 211, and a control instruction unit 212. In addition, the information processing device 230 is constituted of a route information acquisition unit 231, a congestion degree calculation unit 232, a following route planning unit 233, and a control instruction determination unit 234. Meanwhile, the movable apparatuses 220 are each constituted of a control instruction reception unit 221 and a movement control unit 222.

The route information acquisition unit 231 acquires information on scheduled routes of all the movable apparatuses 220 under management and outputs it to the congestion degree calculation unit 232 and the following route planning unit 233.

The congestion degree calculation unit 232 calculates the congestion degree based on the route information input by the route information acquisition unit 231 and outputs it to the following route planning unit 233.

The following route planning unit 233 decides whether or not to cause each of the movable apparatuses 220 to perform following route and determines a section to perform following route based on the route information input by the route information acquisition unit 231 and the congestion degree input by the congestion degree calculation unit 232, and the following route planning unit 233 outputs results to the control instruction determination unit 234.

The control instruction determination unit 234 determines a control instruction to the movable apparatus 220 determined to perform following route by the following route planning unit 233 for movement control in which the movable apparatus 220 switches from autonomous traveling to following route and outputs it to a control instruction transmission unit 212.

The display unit 211 has, for example, a display device, receives information output by the following route planning unit 233 and the control instruction determination unit 234, and outputs it to the display device.

The control instruction transmission unit 212 transmits a control instruction determined by the control instruction determination unit 234 to the control instruction reception unit 221 of each of the movable apparatuses 220.

The control instruction reception unit 221 receives a control instruction from the control instruction transmission unit 212 of the central control system 210 and outputs the received control instruction to the movement control unit 222.

The movement control unit 222 performs movement control of the movable apparatuses 220 based on the control instruction input by the control instruction reception unit 221.

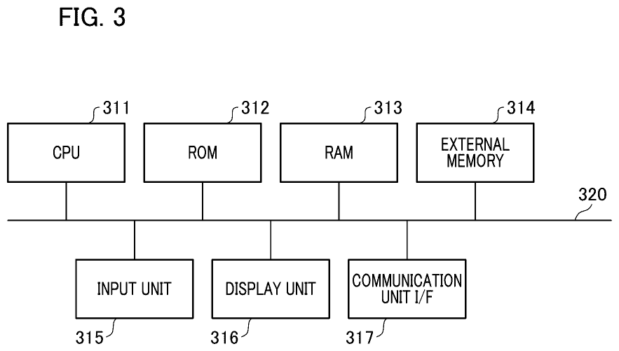

FIG. 3 is a view showing a hardware constitution of the information processing device 230. The information processing device 230 has a CPU 311, a ROM 312, a RAM 313, an external memory 314, an input unit 315, a display unit 316, a communication I/F 317, and a system bus 320 connecting these to each other. I/F is an abbreviation of an interface.

The CPU 311 controls various kinds of devices connected to the system bus 320. CPU is an abbreviation of a central processing unit.

The ROM 312 stores programs of a BIOS and a booting program. ROM is an abbreviation of a read only memory. BIOS is an abbreviation of a basic input output system.

The external memory 314 stores applications, other programs, various kinds of data, files, and the like processed by the information processing device 230. For example, the external memory 314 is a memory such as a hard disk (HD) or a solid state drive (SSD).

The RAM 313 is used as a main storage device of the CPU 311. RAM is an abbreviation of a random access memory. In addition, the RAM 313 also functions as a work area.

The CPU 311 comprehensively controls each of the units connected to the system bus 320 by loading the program according to the present embodiment stored in the ROM 312 or the external memory 314 into the RAM 313 and executing it.

In the present embodiment, when the CPU 311 executes the program, the route information acquisition unit 231, the congestion degree calculation unit 232, the following route planning unit 233, and the control instruction determination unit 234 are realized.

The input unit 315 is an input unit such as a keyboard, a pointing device, a robot controller, or the like and receives an input from a user. The display unit 316 has a display device such as a liquid crystal display and outputs processing results of the information processing device 230 to the display device in response to a command from the CPU 311.

The display device of the display unit 316 may be a liquid crystal display device, a projector, an LED indicator, a head-mounted display that can perform virtual reality (VR) display, or the like. LED is an abbreviation of a light emitting diode. VR is an abbreviation of virtual reality.

In addition, the input unit 315 and the display unit 316 may be constituted of a touch panel. A GUI can be constituted as if a user could directly operate a screen displayed in the touch panel by associating input coordinates and display coordinates in the touch panel with each other. GUI is an abbreviation of a graphical user interface.

The communication I/F 317 performs information communication with an external device via a network. The communication I/F 317 may be of any kind, such as Ethernet, a USB, serial communication, or radio communication. USB is an abbreviation of a universal serial bus.

A network with which the communication I/F 317 corresponds may be constituted of at least any one of a communication network such as a LAN or a WAN, a cellular network, or a radio network, for example.

LAN is an abbreviation of a local area network. WAN is an abbreviation of a wide area network. For example, a cellular network is an LTE, 5G, or the like. LTE is an abbreviation of long-term evolution.

5G is an abbreviation of 5th Generation (5th-generation movement communication system). That is, a network with which the communication I/F 317 corresponds need only be constituted to be able to transmit and receive data, and any method may be employed as a communication method of a physical layer.

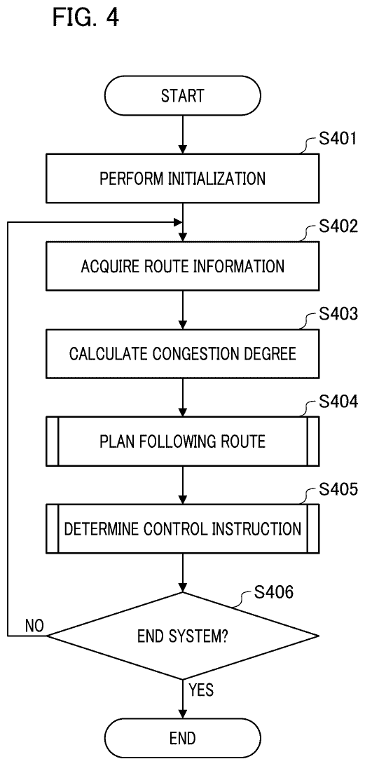

FIG. 4 is a flowchart showing the processing in its entirety executed by the information processing device 230 according to First Embodiment. Each step of the processing shown in the flowchart of FIG. 4 is realized by the CPU 311 of the information processing device 230 causing the RAM 313 to read the program stored in the ROM 312 or the external memory 314 and executing it.

The system according to the present embodiment aims to make a route plan generally efficient, and the following processing starts when a new transportation task is generated and a route plan is required.

In Step S401, the CPU 311 initializes the information processing device 230. Initialization of the information processing device 230 is processing in which the CPU 311 reads a program from the ROM 312 or the external memory 314 such that the information processing device 230 is in an operable state.

In addition, the CPU 311 reads a following route plan for the movable apparatuses 220 or a threshold used when a control instruction to the movable apparatuses 220 is determined from the external memory 314 and stores it in the RAM 313.

In Step S402, the route information acquisition unit 231 acquires information on scheduled routes of all movable apparatuses scheduled to be transported. The automated transportation system 200 receives a transportation task from a higher-level system for managing a warehouse or a factory, for example, from a WMS, an MES, or the like, allocates the task to arbitrary movable apparatuses, and generates a transportation route of each of the movable apparatuses.

WMS is an abbreviation of a warehouse management system. MES is an abbreviation of a manufacturing execution system.

The route information acquisition unit 231 acquires route information related to the generated transportation route. The route information includes information on the start position, the destination position, and the waypoint of each of the movable apparatuses. The route information is set for each of the movable apparatuses.

In Step S403, the congestion degree calculation unit 232 calculates the congestion degree based on the route information input by the route information acquisition unit 231. The congestion degree is obtained for each of the sections provided by dividing scheduled routes of movable apparatuses into a plurality of sections.

The congestion degree is calculated by obtaining the density of movable apparatuses present at the same time for each of the sections. In the present embodiment, the density of movable apparatuses for each of the sections is obtained by counting the number of pieces of route information including the sections as a part of the route within a particular time range.

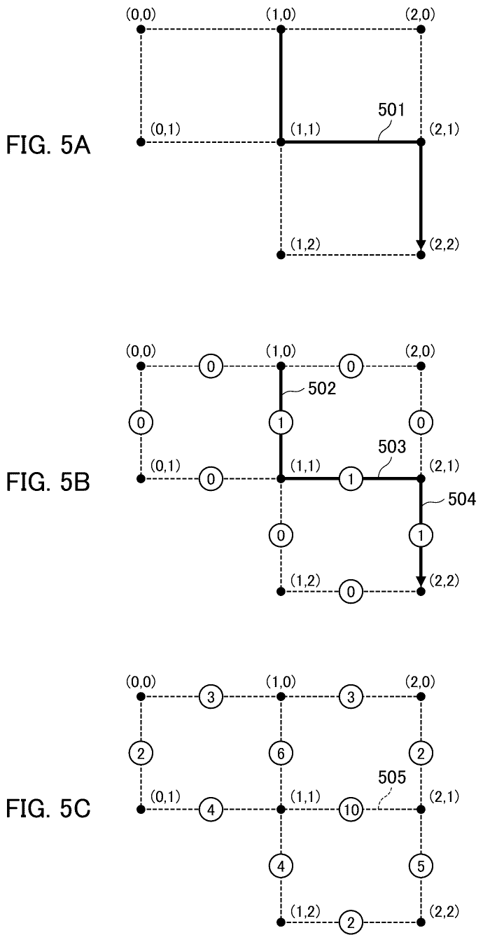

A calculation example of the congestion degree will be described using FIG. 5. FIG. 5A is a view visualizing one certain route in route information. Points that can be the start position, the destination position, and the waypoints of a route of a movable apparatus are indicated by black dots, and each point has coordinates (x, y).

An arrow 501 indicated by the solid arrow in FIG. 5A is an example of route information and indicates a route and a forward movement direction of a movable apparatus. The route indicated by the arrow 501 has the start position at coordinates (1, 0), has the waypoints at coordinates (1, 1) and coordinates (2, 1), and has the destination position at coordinates (2, 2).

The congestion degree indicating the density of movable apparatuses in each of the sections is calculated based on such route information. In the present embodiment, line segments of the dotted lines connecting an arbitrary black dot and an adjacent black dot in FIG. 5A (also including the section of the arrow 501) are set as target sections for calculation of the congestion degree, and the number of line segments included in each of the routes in the route information is counted for each of the sections.

For example, in the case of the route of solid lines in FIG. 5A, regarding the congestion degree, three sections 502, 503, and 504 have a congestion degree 1 as in FIG. 5B, and other sections have a congestion degree 0. An example of the congestion degree at a certain point of time calculated using the foregoing calculation method based on the route information of all the movable apparatuses is shown in FIG. 5C.

In FIG. 5C, for example, the congestion degree of a section 505 that is a section between the coordinates (1, 1) and the coordinates (2, 1) is 10.

In Step S404, the following route planning unit 233 plans whether or not to cause each of the movable apparatuses to perform following route and a section to perform following route based on the route information input by the route information acquisition unit 231 and the congestion degree input by the congestion degree calculation unit 232. A detailed processing procedure of these planning methods will be described below.

In Step S405, the control instruction determination unit 234 determines a control instruction for movement control in which each of the movable apparatuses switches from autonomous traveling to following route on the basis of a following route plan input by the following route planning unit 233. A detailed processing procedure of this method for determining a control instruction will be described below.

In Step S406, the CPU 311 decides whether or not to end the system (stops the information processing device 230). Specifically, the CPU 311 ends the system if an end instruction from a user is received by the input unit 315. Otherwise, the processing returns to Step S402 and continues.

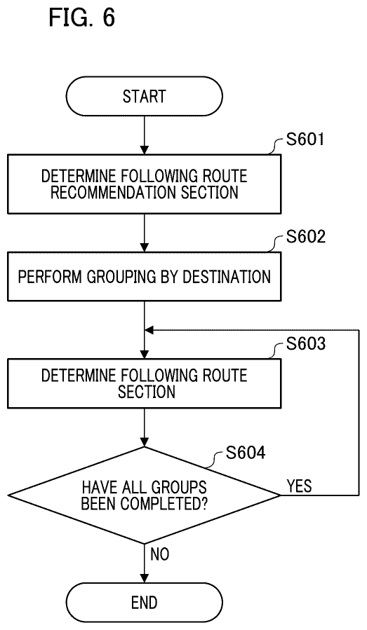

FIG. 6 is a flowchart showing a detailed processing procedure of a following route plan in Step S404.

In Step S601, the following route planning unit 233 determines the section with a high congestion degree as a section in which a plurality of movable apparatuses should perform following route (this section will be referred to as a following route recommendation section). A threshold that has been stored in the RAM 313 in advance is used as a threshold for deciding whether the congestion degree is high.

In the present embodiment, it is assumed that this threshold is a congestion degree 8. In FIG. 5C, since the congestion degree of the section 505 is 10 which is higher than the congestion degree 8, the section is determined as a following route recommendation section. In FIG. 5C, since the congestion degrees of the sections other than the section 505 are lower than 8, the sections other than the section 505 are not the following route recommendation section.

In Step S602, the following route planning unit 233 groups the routes of the movable apparatuses by destination. Regarding a flow of grouping, first, it is classified whether or not a movable apparatus scheduled to travel performs following route in a target route depending on whether or not the target route includes the following route recommendation section. Next, grouping is performed such that routes having the same destination position belong to the same group.

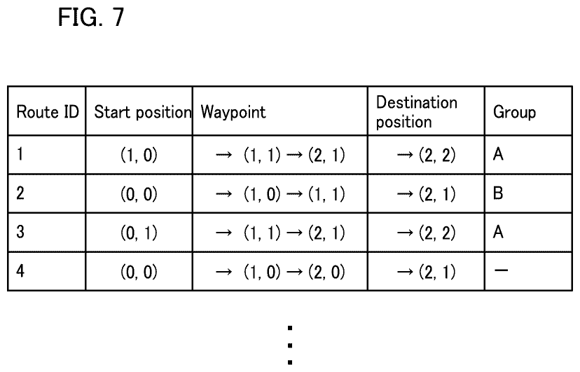

An example of grouping will be described with reference to FIG. 7. FIG. 7 is a table showing a part of route information acquired from the route information acquisition unit 231, and a row for Group is added to the table in addition to the rows for Route ID, Start Position, Waypoints, and Destination Position.

First, within a section from the start position to the destination position of each of the routes, a grouping target is classified depending on whether or not to include a following route recommendation section determined in Step S601.

In the case of FIG. 7, since the route having a route ID 4 does not include the following route recommendation section (the route 505 in FIG. 5C), it is irrelevant to the grouping target, and “−” is indicated the row for Group of the route ID 4. On the other hand, route IDs 1, 2, and 3 are the grouping target.

Next, classification is performed such that the route IDs having the same destination position are in the same group. In FIG. 7, since the destination positions of the route ID 1 and the route ID 3 are the same, these two routes are classified as the same group A, and the route ID 2 is classified as a different group B.

The movable apparatuses traveling in the route that has become the grouping target in this processing become the movable apparatuses that are the following route targets, and following route is not applied to the movable apparatuses irrelevant to the grouping target and they are subjected to movement control of only autonomous traveling.

In Step S603, the following route planning unit 233 determines a following route section for each of the groups classified in Step S602. In the present embodiment, the following route recommendation section is set as the section where following route of the movable apparatuses starts, and the following route section is set such that the destination position of the group becomes the spot where the following route ends.

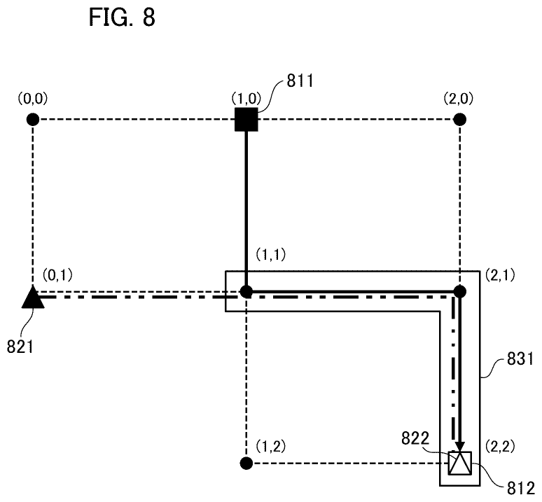

Here, the following route section of the group A will be described using FIG. 8. In FIG. 8, the routes of the route ID 1 and the route ID 3 in FIG. 7 are visualized. In the route of the route ID 1, the start position is a spot 811, the destination position is a spot 812, and the route is indicated by a solid line. Meanwhile, in the route of the route ID 3, the start position is a spot 821, the destination position is a spot 822, and the route is indicated by a two-dot dashed line.

The following route recommendation section is a section between the coordinates (1, 1) and the coordinates (2, 1), and the destinations of the route ID 1 and the route ID 3 are the coordinates (2, 2). For this reason, a section 831 having the coordinates (1, 1) as a start point and the coordinates (2, 2) as an end point is determined as the following route section. The foregoing processing procedure is performed with respect to all the groups, and the following route section is determined for each of the groups.

In Step S604, the following route planning unit 233 decides whether or not to end the processing for a following route plan. The following route planning unit 233 ends if the processing is completed with respect to all the groups that have been grouped. Otherwise, the following route planning unit 233 returns to Step S603 and continues the processing.

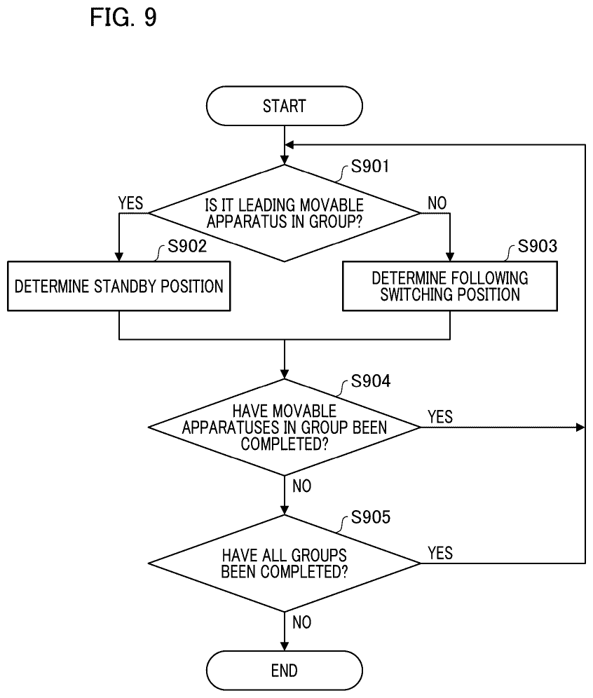

FIG. 9 is a flowchart showing a detailed processing procedure of determination of a control instruction in Step S405. The control instruction determination unit 234 determines a control instruction with respect to the movable apparatuses in the group for each of the groups classified in Step S602.

In Step S901, the control instruction determination unit 234 decides whether or not a movable apparatus that is a determination target of a control instruction is a leading movable apparatus in the group, that is, whether or not it is a movable apparatus that first enters the following route section in the group. If the movable apparatus is the leading movable apparatus, the processing proceeds to Step S902, and if the movable apparatus is a movable apparatus other than the leading movable apparatus, the processing proceeds to Step S903.

In Step S902, the control instruction determination unit 234 determines a standby position within the following route section with respect to the leading movable apparatus in the group. In the group, since the leading movable apparatus leads the succeeding movable apparatus, itself does not switch from autonomous traveling to following route and continuously performs autonomous traveling even within the following route section.

However, if the distance to the leading movable apparatus is equal to or longer than a certain distance when a succeeding movable apparatus having the leading movable apparatus as a following target enters the following route section, since it is a distance difficult to perform following route, there is a probability that it cannot switch from autonomous traveling to following route.

Regarding a following method in the present embodiment, since the movable apparatuses that are the following targets within the following route section travel in the same route, a method in which movable apparatuses are caused to travel such that the values of distance sensors on front surfaces of the movable apparatuses are within a threshold is used.

For this reason, the leading movable apparatus itself needs to enter the following route section and stand by until the succeeding movable apparatus arrives at a position closer than that within this threshold. Hence, the control instruction determination unit 234 determines, as a control instruction, a position where the leading movable apparatus stands by.

Regarding this method for determining a standby position, the sum of the overall lengths of the succeeding movable apparatuses in the group and the distance intervals with respect to the preceding movable apparatuses when each of the movable apparatuses performs following route is obtained.

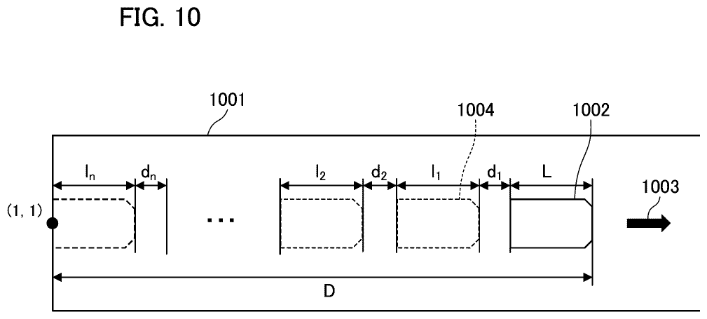

Here, an example of the standby position of the leading movable apparatus is shown in FIG. 10. FIG. 10 shows standby positions of respective movable apparatuses if the number of movable apparatuses included in the group is n. A following route section 1001 indicates a section in which the movable apparatuses of this group perform following route and which is an entrance part of the section 831 in FIG. 8.

A movable apparatus 1002 is the leading movable apparatus. An arrow 1003 indicates the forward movement direction of the movable apparatuses. A movable apparatus 1004 is a first following movable apparatus counting from the leading movable apparatus.

The control instruction determination unit 234 obtains a position where the leading movable apparatus 1002 stands by in consideration of the position where the succeeding movable apparatuses other than the leading movable apparatus stop. The control instruction determination unit 234 first obtains a distance D from the entrance of the following route section 1001 to the leading movable apparatus 1002. The control instruction determination unit 234 calculates the distance D using Expression 1.

$$D = {\sum }_{i = 1}^{n} ( {l}_{i} + {d}_{i} ) + L \qquad ( 1 )$$

In Expression 1, the overall length of the leading movable apparatus 1002 is L, the overall length of an ith following movable apparatus counting from the leading movable apparatus is lᵢ, and the distance interval with respect to the preceding movable apparatus allowing the ith following movable apparatus to switch to following route is dᵢ. In Expression 1, the sum of the overall lengths of the following movable apparatuses and the distance intervals therebetween is obtained, and a result is obtained as the distance D by adding the overall length L of the leading movable apparatus to this sum.

In the present embodiment, the leading movable apparatus 1002 stands by at the position where the distance D is added to the entrance of the following route section 1001. In the example of FIG. 8, the coordinates of the standby position of the leading movable apparatus 1002 are coordinates (1+D, 1).

In Step S903, the control instruction determination unit 234 determines a position where the movable apparatuses other than the leading movable apparatus in the group switch between autonomous traveling and following route. In this determination method, similar to the method for calculating the standby position of the leading movable apparatus 1002, the switching position is determined based on the sum of the overall lengths and the distance intervals of the movable apparatuses succeeding a target movable apparatus to be obtained.

A specific example will be described using FIG. 10. The position where the first following movable apparatus 1004 counting from the leading movable apparatus switches to following route need only add the overall length (l₁) of itself to the sum of the overall lengths of the second and subsequent following movable apparatus (l₂ and so on to lₙ) and the distance intervals (d₂ and so on to dₙ). This is mathematically expressed by Expression 2.

$${D}_{m} = {\sum }_{i = m + 1}^{n} ( {l}_{i} + {d}_{i} ) + {l}_{m} \qquad ( 2 )$$

Expression 2 is a mathematical expression for obtaining a switching position Dₘ of a mth following movable apparatus for following route from the leading movable apparatus. According to the foregoing method, the switching position from autonomous traveling to following route can be determined.

On the other hand, the return position from following route to autonomous traveling is near the exit of the following route section. In the present embodiment, since the exit of the following route section is synonymous with the destination position, the position where the distance to the destination position becomes equal to or smaller than the threshold that is stored in the RAM 313 is determined as the switching position from following route to autonomous traveling.

In Step S904, the control instruction determination unit 234 decides whether or not the processing of determining the standby position and determining the following switching position with respect to all the movable apparatuses in the group has been completed. If the processing with respect to all the movable apparatuses in the group has been completed, the processing proceeds to Step S905. Otherwise, the processing returns to Step S901.

In Step S905, the control instruction determination unit 234 decides whether or not the processing of determining the standby position and determining the following switching position with respect to all the groups has been completed. If the processing with respect to all the groups has been completed, the processing of determining a control instruction ends. Otherwise, the processing returns to Step S901 and continues.

### <Effects>

As above, according to the present embodiment, movement efficiency of a plurality of movable apparatuses can be improved.

### Modification Example 1-1

In First Embodiment, the congestion degree calculation unit 232 calculates the congestion degree on the basis of the route information, but the present embodiment is not limited to this and can be modified with any method other than that based on the route information as long as the method can calculate a congestion degree. For example, the present embodiment may use a method for calculating the congestion degree on the basis of auxiliary information provided by a user or a method for calculating the congestion degree on the basis of information acquired from each of the movable apparatuses.

If the congestion degree is calculated on the basis of auxiliary information provided by a user, the section in which the user desires to perform following route or the section which the user predicts to congest is input by the user from the input unit 315. The following route planning unit 233 may determine the following route section on the basis of this input information.

If the congestion degree is calculated on the basis of the information acquired from each of the movable apparatuses, the congestion degree calculation unit 232 calculates the total of the number of times of stops and deceleration of the movable apparatuses for each of the sections using traveling state information such as temporary stops and emergency stops of the movable apparatuses and speed information such as speed reduction and deceleration. The congestion degree calculation unit 232 may calculate the congestion degree on the basis of the total of the number of times of stops and deceleration of the movable apparatuses.

The congestion degree calculation unit 232 may set the congestion degree to be high if the frequency of detecting an obstacle by an obstacle sensor is high. In addition, the congestion degree calculation unit 232 may set the congestion degree to be higher as the reliability is lower on the basis of the reliability of a position/posture (position and orientation) measurement sensor.

If the calculation method is performed on the basis of auxiliary information provided by a user, there is an effect that a following route plan can be established in consideration of user's convenience. Meanwhile, if the calculation method is performed on the basis of the information acquired from each of the movable apparatuses, there is an effect that the following route section can be set to the most suitable section at all times in the case of a circumstance in which the congestion section varies from time to time.

In addition, in First Embodiment, the congestion degree calculation unit 232 divides the route in order to calculate the congestion degree, and division granularity thereof is set such that a straight section connecting route branching points to each other as in FIG. 5 is one section, but the present embodiment is not limited to this.

In the present embodiment, the division granularity does not matter as long as the section is a part of the route. For example, the congestion degree may be obtained every 1 m with a straight-line distance of 1 m as the division granularity of the section. There is an effect that the range of following route can be more finely adjusted by setting finer division granularity of the section in this manner.

### Modification Example 1-2

In First Embodiment, the following route planning unit 233 groups the movable apparatuses that are the following route targets by destination, but the present embodiment is not limited to this. The present embodiment can be modified with grouping other than that by destination as long as they can be classified into groups on the basis of the attribute of the routes or the movable apparatuses.

For example, grouping may be performed based on the traveling speed or the size of the movable apparatus in place of the destination. If grouping is performed based on the traveling speed, there is an effect that movement is made efficient by preferentially causing the faster group to pass through within the following route section.

In addition, if grouping is performed based on the size of the movable apparatus, an upper limit may be set on the lengths of the efficient movable apparatuses in convoy in consideration of the length of the movable apparatuses in convoy obtained from the lengths of the overall lengths of the movable apparatuses performing following route. For example, if there is an intersection where only one movable apparatus can enter at a time, the movable apparatuses in another lane cannot pass through the intersection for a while and stand by while a long convoy is passing by.

For this reason, there is an effect that transportation is made efficient by excluding movable apparatuses having an overall length that is equal to or longer than a certain length from the target of following route, such as from the group.

In addition, in First Embodiment, in grouping by destination, the following route planning unit 233 divides the group by only deciding whether or not the group is the same as the method for dividing the group, but the present embodiment is not limited to this.

In the present embodiment, the group can be more finely divided by adding other attribute information if it can be divided into the movable apparatuses having the same attribute. In this manner, the present embodiment may have an attribute classification unit that classifies and groups each of the plurality of movable apparatuses by attribute.

This attribute may be at least one of the destination position in the route of each of the plurality of movable apparatuses, the traveling speed of each of the plurality of movable apparatuses, and the size of each of the plurality of movable apparatuses.

For example, the group may be divided in consideration of a time axis, or an upper limit value or a lower limit value may be set on the number of movable apparatuses in the group and the group may be divided on the basis thereof. If the group is divided in consideration of the time axis, there is an effect that the standby time of each of the movable apparatuses performing following route for the succeeding movable apparatus is shortened and more efficient following route can be realized by dividing them such that the movable apparatuses having an earlier entry time with respect to the following route section are in the same group.

Meanwhile, if the group is divided by determining the upper and lower limits on the number of movable apparatuses in the group, specifically, the upper and lower limits may be set in accordance with the size of the movable apparatus or the width and the depth of the passage. In the case of a determination method performed on the basis of the size of the movable apparatus (width or overall length), if a plurality of large movable apparatuses travel in convoy, the efficiency of passing an intersection can be improved by providing a limitation as described above.

For this reason, there is an effect that transportation efficiency can be improved by strictly setting the upper limit value (reducing the upper limit value) as the size of the movable apparatus increases.

In addition, in the case of a method in which the upper limit value is strictly set (the upper limit value is reduced) as the width and the depth of the passage becomes narrower and shorter, there is an effect that the number of constituent movable apparatuses in most suitable convoy can be determined in accordance with the field environment.

Moreover, in addition to the upper and lower limits on the movable apparatuses in the group, the specific constitution of the movable apparatuses in convoy in one group may be varied. For example, the number of rows in convoy may be changed in accordance with the congestion degree. If the congestion degree is high, there is an effect that transportation can be performed more efficiently by increasing the number of rows and causing them to perform following route in a plurality of rows.

In addition, the following route planning unit 233 does not necessarily require grouping with respect to the movable apparatuses that are the following route targets, only whether or not each of the movable apparatuses performs following route within the following route section may be determined without performing grouping. In that case, the control instruction determination unit 234 determines the movable apparatus that is the following target on the basis of the entry time of each of the movable apparatuses to the following route section.

### Modification Example 1-3

In First Embodiment, the control instruction determination unit 234 determines the standby position and the following switching position of the movable apparatuses in the group for following route, but the present embodiment is not limited to this. In the present embodiment, the determination target can be modified to that other than positional information as long as a control instruction with respect to each of the movable apparatuses in the group can be determined.

For example, the time information, the following method, the movement control method, or the sensor control method may be a control instruction target. In the case of the time information, a time to wait for the succeeding movable apparatus in the group and restart traveling is set to the leading movable apparatus, and a time to enter the following route section is set to the movable apparatuses other than the leading movable apparatus in a manner of being delayed little by little in accordance with the following order in the group. Accordingly, there is an effect that switching control to following route can be smoothly performed.

In the case of the following method, regarding a specific method, a method for movement control in which a marker is disposed in the rear part of the preceding movable apparatus and it moves forward in the direction of the marker using a marker recognition technology may be used. In addition, a method for movement control in which self-position information is received from the preceding movable apparatus using communication between the movable apparatuses and it moves toward the position where the preceding movable apparatus is present may be used.

There is an effect that a following method that can be realized in accordance with the circumstances at the time, such as whether the marker can be recognized with respect to the preceding movable apparatus or whether the positional information can be received from the preceding movable apparatus through communication, can be selected using these methods.

In the case of the movement control method, the traveling speed is set to be lower as the congestion degree becomes higher, or the distance interval of the movable apparatus performing following route with respect to the front is set to be narrower as the congestion degree becomes higher. Accordingly, there is an effect that the traveling speed and the distance interval suitable for the congestion condition are obtained, which leads to efficient movement.

In the case of the sensor control method, the obstacle sensor or the position/posture measurement sensor in the front is invalidated when the congestion degree is high, or the measurement range of the obstacle sensor is narrowed as the congestion degree becomes higher. Accordingly, there is an effect that a temporary stop, deceleration, or the like due to erroneous detection or instability of the obstacle detection sensor or the position/posture measurement sensor can be curbed and transportation is made efficient.

### Modification Example 1-4

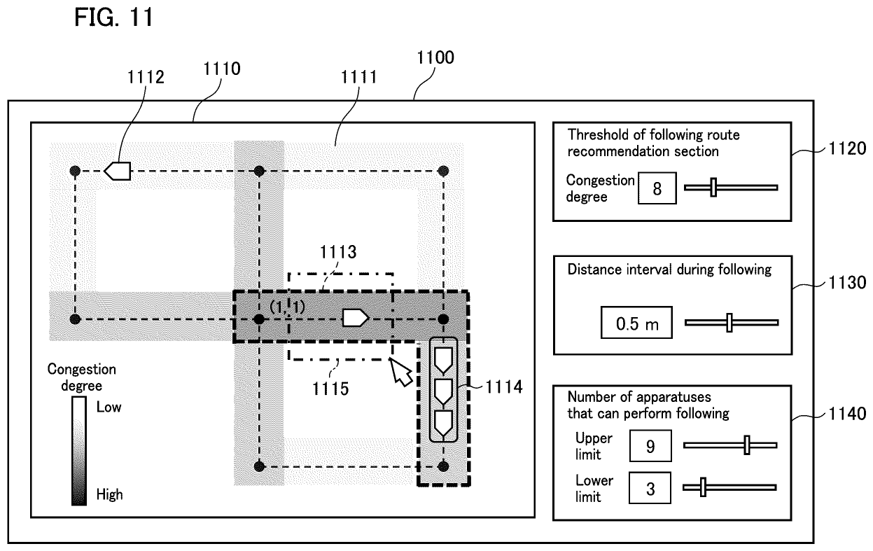

In First Embodiment, regarding planning of following route by the information processing device 230 and determination of a control instruction to each of the movable apparatuses, a user may perform confirmation or adjustment using a GUI displayed in the display unit 211. FIG. 11 is a view showing a GUI 1100 in which a following route plan and a control instruction are displayed or corrected.

A GUI 1110 is a GUI for displaying the following route section determined by the following route planning unit 233 and whether or not each of the movable apparatuses performs following route. The GUI 1110 displays the route in FIG. 5 according to First Embodiment. The congestion degree of each of the routes in FIG. 5C is visualized using a heat map as indicated by a display 1111, and the route having a higher congestion degree is displayed to have darker blackness within the region.

A display 1112 indicates a currently traveling movable apparatus that is mapped on the route. A display 1113 indicates the following route section determined by the following route planning unit 233, and the group of the movable apparatuses performing following route among the movable apparatuses traveling within the following route section is surrounded by the frame line as indicated by a display 1114. In addition, a user may set a candidate region for following route as indicated by a display 1115, and a following route planning unit 223 may determine the following route section based on this.

A GUI 1120 is a GUI for adjusting a threshold of a following route recommendation section. In the GUI 1120, it is possible to change the threshold of the congestion degree used when the following route planning unit 233 determines the following route recommendation section in Step S601 by moving a threshold adjustment bar from side to side.

A GUI 1130 is a GUI for adjusting the distance interval during following. In the GUI 1130, it is possible to adjust parameters used when a control instruction determination unit 214 determines the following route start position of each of the movable apparatuses in Steps S902 and S903 by moving the threshold adjustment bar.

A GUI 1140 is a GUI for adjusting the number of movable apparatuses that can perform following. In the GUI 1140, it is possible to adjust the thresholds of the upper limit and the lower limit on the number of movable apparatuses in the group when a following route planning unit 213 performs grouping in Step S602 by moving the adjustment bar.

The display unit 211 may display information other than the information indicated by the GUI 1100. For example, the display unit 211 may acquire the following route start position of each of the movable apparatuses from the control instruction determination unit 234 and display it on the route.

Display contents in the display unit 211 may be displayed in the display unit 316. The display unit 211 may output at least one of information related to following route determined by the following route planning unit 233 and control instruction information with respect to each of the plurality of movable apparatuses determined by the control instruction determination unit 234 to the display device.

In addition, as the purpose of the display unit 211, information may be presented to persons around the movable apparatuses 220 in addition to presenting the foregoing information for a manager of the automated transportation system 200. For example, a three-color light having red, yellow, and green can be used as the display unit 211. In this case, the yellow light may be turned on during following route and the green light may be turned on during autonomous traveling.

In addition, instead of displaying in the display unit 211, or in addition to displaying in the display unit 211, an audio guide may be used for informing of following route. In addition, the display unit 211 may present a time when the group performing following route passes through and allow surrounding workers to ascertain the time zone during which they cannot pass through such that it is useful for determining the route in which workers pass through, the timing for passing through, and the like.

As above, in the present modification example, due to the GUI presenting parameter inputs or processing results during planning of following route or during determination of a control instruction to each of the movable apparatuses, intuitive understanding of a user can be prompted, and convenience during planning of following route and during determination of a control instruction can be further improved.

The control instruction determination unit 234 may determine at least any of the traveling speed, the distance interval with respect to the preceding movable apparatus, and the measurement parameters of the sensor mounted in the movable apparatus with respect to a movable apparatus performing following route within the following route section.

### Second Embodiment

Hereinafter, Second Embodiment will be described. In First Embodiment, the congestion degree is calculated on the basis of the scheduled route of a movable apparatus, and the following route section or a target movable apparatus is determined on the basis of the congestion degree.

In Second Embodiment, regardless of the congestion degree, a plurality of movable apparatuses are caused to perform following route if the destinations thereof are close to each other. Motives for following route of movable apparatuses in addition to improvement of the transportation efficiency at the time of congestion include a purpose of improving the entire work efficiency including workers.

For example, when considering an automated transportation system, after a movable apparatus transports goods and arrives at a destination, human labor may always be required for unloading or work after unloading. In such a case, since work can be collectively performed if the times when a plurality of movable apparatuses arrive at one certain destination or surroundings are concentrated, it is better for a worker to use time efficiently.

Hence, in Second Embodiment, movable apparatuses are classified for each destination area, a common route of the movable apparatuses in the same classification is estimated, and a plurality of movable apparatuses are caused to perform following route on the common route.

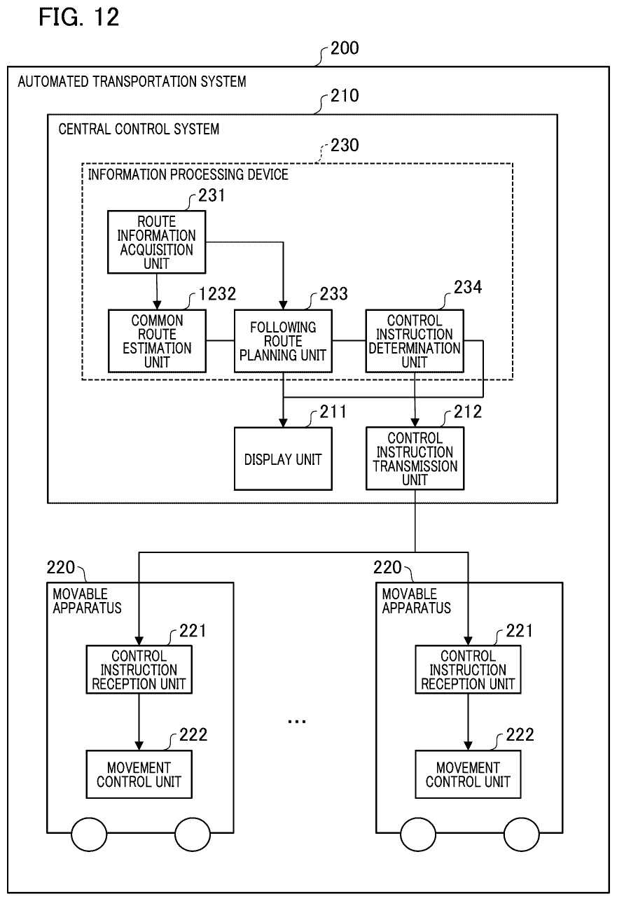

FIG. 12 is a view showing an example of a constitution of the automated transportation system including the information processing device according to the present embodiment. The functional constitution of the information processing device according to Second Embodiment differs in having a common route estimation unit 1232 instead of the congestion degree calculation unit 232 with respect to the functional constitution of the information processing device 230 in FIG. 2 described in First Embodiment.

In Second Embodiment, since processing other than that according to the common route estimation unit 1232 is similar to First Embodiment, description thereof will be omitted.

The common route estimation unit 1232 according to Second Embodiment estimates a common route of a plurality of movable apparatuses based on the route information input by the route information acquisition unit 231. The common route estimation unit 1232 outputs the estimated information on the common route to the following route planning unit 233.

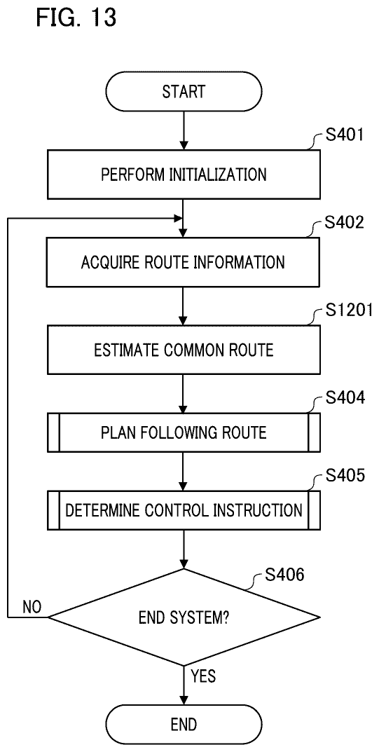

FIG. 13 is a flowchart showing processing in its entirety executed by the information processing device 230 according to Second Embodiment. Description of steps that are the same as those in FIG. 4 describing the processing procedure of the information processing device 230 described in First Embodiment is omitted and only the processing procedure different from that of First Embodiment will be described.

In Step S401, the CPU 311 initializes the information processing device 230. At this time, the CPU 311 reads the threshold used at the time of estimating a common route from the external memory 314 and stores it in the RAM 313.

In Step S1201, the common route estimation unit 1232 estimates a common route based on the route information input by the route information acquisition unit 231. Regarding a method for estimating a common route, area dividing of regions in which movable apparatuses may travel is performed, a route in which the destination position is in the same area is extracted from the route information, and an overlapping route section in the extracted routes is adopted as the common route.

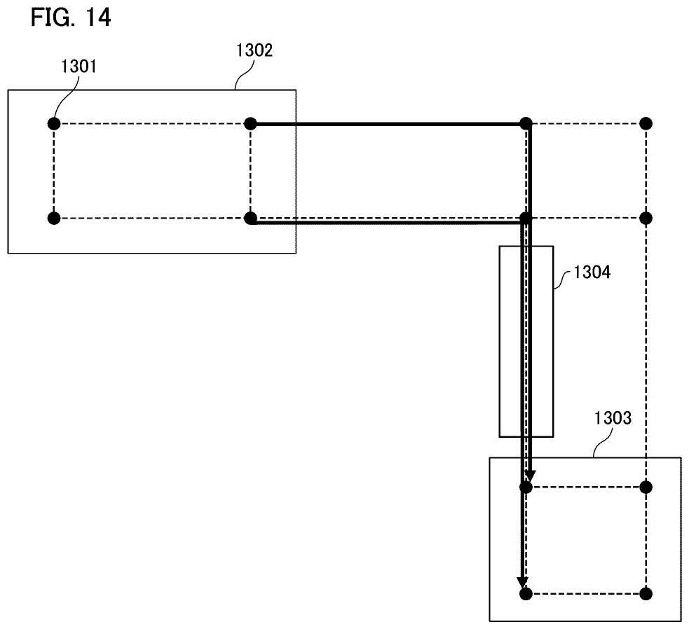

A specific example of the method for estimating a common route will be described using FIG. 14. In FIG. 14, black dots 1301 are examples of spots that may be the start position, the destination position, and the waypoints. First, an area is divided such that points with a Euclid distance having a value equal to or smaller than the threshold stored in the RAM 313 between spots that will become the destination positions in the route information are in the same area. In FIG. 14, the area is divided into two areas, such as an area 1302 and an area 1303.

Next, in the route information, the route section commonly included in the routes to the destination positions which belong to the same area is estimated. The solid arrow in FIG. 14 indicates two certain routes. In the case of these two routes, the common route section is a route section 1304. For this reason, in this case, an estimation result having the route section 1304 as a common route is obtained.

In Step S404 of Second Embodiment, in the processing procedure of First Embodiment shown in FIG. 6, processing of Step S601 and Step S602 are skipped without being performed, and only the processing of Step S603 is executed. In Step S603, the following route planning unit 233 determines the common route estimated in Step S1201 as the following route section.

### <Effects>

As above, according to the present embodiment, movement efficiency of a plurality of movable apparatuses can be improved. Moreover, work in its entirety can be made efficient in consideration of other work depending on arrival of movable apparatuses.

### Modification Example 2-1

In Second Embodiment, the common route estimation unit 1232 divides an area depending on destination position based on the route information, but the present embodiment is not limited to this and it is possible to make modification having a target other than the destination position as long as the target allows area dividing. For example, an area may be divided depending on the start position in place of the destination position.

If an area is divided depending on the start position, in the case in which a plurality of movable apparatuses collectively have empty apparatuses within a region at a certain distance, they can start in convoy at the same timing. For this reason, for example, there is an effect that work at the start position such as loading can be performed in a temporally concentrated manner and the entire work efficiency is improved. In addition, in the present embodiment, an area may be divided depending on both the start position and the destination position.

In addition, in Second Embodiment, the common route estimation unit 1232 estimates a common route section with respect to the route determined in advance, but the present embodiment is not limited to this and can be modified to that other than the route determined in advance as long as a common route section can be estimated.

For example, a route having no route section common to other routes may be changed a bypass route such that a route section common to other routes can be provided, and a route section that may be common to the route after change may be estimated as the common route section.

In this case, since a movable apparatus that does not originally have a common route section, that is, a movable apparatus irrelevant to a following target becomes a following target and the arrival timing at the destination position can be harmonized with other movable apparatuses, there is an effect that entire work can be made more efficient.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the information processing device through a network or various storage media. Then, a computer (or a CPU, an MPU, or the like) of the information processing device may be configured to read and execute the program. In such a case, the program and the storage medium storing the program configure the present invention.

In addition, the present invention includes those realized using at least one processor or circuit configured to function of the embodiments explained above, for example. Dispersion processing may be performed using a plurality of processors.

This application claims the benefit of Japanese Patent Application No. 2022-194610, filed on Dec. 6, 2022, which is hereby incorporated by reference herein in its entirety.

What is claimed is:

1. An information processing device planning routes of a plurality of movable apparatuses, the information processing device comprising:
at least one processor or circuit configured to function as:
a route information acquisition unit configured to acquire information on a scheduled route of each of the plurality of movable apparatuses;
a congestion degree calculation unit configured to divide a route acquired by the route information acquisition unit into a plurality of sections and calculate a congestion degree indicating a density of movable apparatuses present within the sections for each of the sections;
a following route planning unit configured to, on the basis of the congestion degree calculated by the congestion degree calculation unit, determine a following route section in which a movable apparatus performs following route with respect to another movable apparatus and determine whether or not to perform following with respect to each of the plurality of movable apparatuses within the following route section; and
a control instruction determination unit configured to determine a control instruction with respect to each of the plurality of movable apparatuses in accordance with a following route plan determined by the following route planning unit.

2. The information processing device according to claim 1 further comprising:
an attribute classification unit configured to classify and group each of the plurality of movable apparatuses by an attribute thereof,
wherein the following route planning unit determines whether or not to perform following route in convoy for each of the groups classified by the attribute classification unit, and a following route section.

3. The information processing device according to claim 2,
wherein the attribute includes at least one of a destination position in a route of each of the plurality of movable apparatuses, a traveling speed of each of the plurality of movable apparatuses, and a size of each of the plurality of movable apparatuses.

4. The information processing device according to claim 1,
wherein the control instruction determination unit determines at least one of a traveling speed, a distance interval with respect to a preceding movable apparatus, and a measurement parameter of a sensor mounted in the movable apparatus with respect to a movable apparatus performing following route within the following route section.

5. The information processing device according to claim 1,
Further comprising a display unit configured to output at least one of information related to following route determined by the following route planning unit and control instruction information with respect to each of the plurality of movable apparatuses determined by the control instruction determination unit to a display device.

6. A control method for an information processing device planning routes of a plurality of movable apparatuses, the control method comprising:
acquiring information on a scheduled route of each of the plurality of movable apparatuses;
dividing a route acquired in the route information acquiring into a plurality of sections;
calculating a congestion degree indicating a density of movable apparatuses present within the sections for each of the sections;
determining a following route section in which a movable apparatus performs following route with respect to another movable apparatus on the basis of the congestion degree calculated in the congestion degree calculating;
planning a following route plan relating to whether or not to perform following with respect to each of the plurality of movable apparatuses within the following route section; and
determining a control instruction with respect to each of the plurality of movable apparatuses in accordance with the following route plan planned in the planning.

7. A non-transitory computer-readable storage medium configured to store a computer program comprising instructions for executing a control method for an information processing device planning routes of a plurality of movable apparatuses and including following processes:
acquiring information on a scheduled route of each of the plurality of movable apparatuses;
dividing a route acquired in the route information acquiring into a plurality of sections;
calculating a congestion degree indicating a density of movable apparatuses present within the sections for each of the sections;
determining a following route section in which a movable apparatus performs following route with respect to another movable apparatus on the basis of the congestion degree calculated in the congestion degree calculating;
planning a following route plan relating to whether or not to perform following with respect to each of the plurality of movable apparatuses within the following route section; and
determining a control instruction with respect to each of the plurality of movable apparatuses in accordance with the following route plan planned in the planning.

8. An information processing device planning routes of a plurality of movable apparatuses, the information processing device comprising:
at least one processor or circuit configured to function as:
a route information acquisition unit configured to acquire information on a scheduled route of each movable apparatus of the plurality of movable apparatuses;
a common route estimation unit configured to, on the basis of a route acquired by the route information acquisition unit, perform area dividing based on at least one of a start position and a destination position and estimate a route section through which each of the plurality of movable apparatuses commonly passes for each divided area;
a following route planning unit configured to determine a common route section estimated by the common route estimation unit as a following route section in which a movable apparatus performs following route with respect to another movable apparatus and determine whether or not to perform following with respect to each of the plurality of movable apparatuses within the following route section; and
a control instruction determination unit configured to determine a control instruction with respect to each of the plurality of movable apparatuses in accordance with a following route plan determined by the following route planning unit.

9. A control method for an information processing device planning routes of a plurality of movable apparatuses, the control method comprising:
route information acquiring of acquiring information on a scheduled route of each movable apparatus of the plurality of movable apparatuses;
common route estimating, on the basis of a route acquired in the route information acquiring, of performing area dividing based on at least one of a start position and a destination position and estimating a route section through which each of the plurality of movable apparatuses commonly passes for each divided area;
following route planning of determining a common route section estimated in the common route estimating as a following route section in which a movable apparatus performs following route with respect to another movable apparatus and determining whether or not to perform following with respect to each of the plurality of movable apparatuses within the following route section; and
control instruction determining of determining a control instruction with respect to each of the plurality of movable apparatuses in accordance with a following route plan determined in the following route planning.

10. A non-transitory computer-readable storage medium configured to store a computer program comprising instructions for executing a control method for an information processing device planning routes of a plurality of movable apparatuses and including following processes:
route information acquiring of acquiring information on a scheduled route of each movable apparatus of the plurality of movable apparatuses;
common route estimating, on the basis of a route acquired in the route information acquiring, of performing area dividing based on at least one of a start position and a destination position and estimating a route section through which each of the plurality of movable apparatuses commonly passes for each divided area;
following route planning of determining a common route section estimated in the common route estimating as a following route section in which a movable apparatus performs following route with respect to another movable apparatus and determining whether or not to perform following with respect to each of the plurality of movable apparatuses within the following route section; and
control instruction determining of determining a control instruction with respect to each of the plurality of movable apparatuses in accordance with a following route plan determined in the following route planning.
